(19) United States
(12) Patent Application Publication
(10) Pub. No.: US 2007/0079335 A1
(43) Pub. Date: Apr. 5, 2007

(54) Generating an alert signal for use with digital video recorders

(76) Inventor: John C. McDonough, Nahant, MA (US)

Correspondence Address: PROSKAUER ROSE LLP, ONE INTERNATIONAL PLACE 14TH FL, BOSTON, MA, 02110, US

(21) Appl. No.: 11/241,819

(22) Filed: Sep. 30, 2005

(51) Int. Cl. H04N 7/173; H04N 7/16; H04N 5/445; G06F 13/00; G06F 3/00

(52) U.S. Cl. 725/58; 725/134; 725/142; 725/89

(57) ABSTRACT

The description herein describes generating an alert signal for use with digital video recorders. In a described implementation, a method for generating an alert includes receiving a first information from a services provider and generating an alert signal. In the implementation, the first information is associated with a customer and is unrelated to television programming. Also in the implementation, the alert signal is generated on a digital video recorder associated with the customer, the alert being based on the first information.

### FIELD OF THE INVENTION

The description relates generally to digital video recorders and, more specifically, to generating alert signals for use with digital video recorders.

### BACKGROUND

Television sets (“TVs”) are found in many homes in the United States. TVs provide entertainment and educational programming, as well as a central location for families to meet and spend time together in a comfortable setting such as a living room. Though TVs of all sizes are often watched by multiple people at the same time, big-screen TVs have risen in popularity since the late nineteen-nineties and provide a crisper picture, a wider viewing angle, and better sound, allowing for easier and more enjoyable multi-person viewing of a given program.

Digital Video Recorders (“DVRs”) have also increased in popularity since the late nineteen-nineties. DVRs provide a means for users to record TV programs, or “shows,” when the user is not available to watch them, much like the Video Cassette Recorder (“VCR”), introduced in the nineteen-seventies, “time-shifts” recorded content. DVRs however go beyond simply scheduling the recording of TV programs. DVRs are typically bundled with a service provided by a digital video recorder services provider. Services provided by the DVR services provider often include scheduling information downloaded from the DVR services provider and the scheduling of “season passes” that instruct the DVR to record every new or currently un-recorded episode of a particular TV show. DVRs also typically allow for TV show recommendations for users based on the user's prior viewing or recording preferences. Examples of DVRs are the TiVo®-brand DVR and the ReplayTV®-brand DVR. DVR service providers for these DVRs are TiVo, Inc. of Alviso, CA and ReplayTV of Santa Clara, California, a Digital Networks North America Company, respectively.

Financial services providers typically provide a wide array of offerings to their clients such as managing stocks and other investments, providing insurance policies, banking services, as well as providing financial advice. Financial services providers often mail or email financial statements to clients that show account information such as portfolio holdings, portfolio value, as well as historic performance or account value data.

### SUMMARY OF THE INVENTION

A method for generating an alert signal is provided. In one implementation, the method includes receiving a first information from a services provider and generating an alert signal. In the implementation, the first information is associated with a customer and is unrelated to television programming. The alert signal is generated on a digital video recorder associated with the customer, the alert being based on the first information.

In some implementations, there is an additional or alternate method for generating an alert signal. The method includes performing a calculation and generating an alert signal for use with a digital video recorder when the calculation meets a first criterion. The calculation is based on a first information, the first information being associated with a customer and typically unrelated to television programming.

Implementations described herein also enjoy the following advantages. In some implementations, the alert signal is sent from a services provider. The services provider is a digital video recorder services provider or, additionally or alternatively, the services provider is a financial services provider. In some implementations, the first information includes financial information, which may include a news story about a company (where the customer owns a share of stock of the company), a price for a stock owned by the customer, stocks selected to be monitored, a stream of financial data, a list of stock quotes selected by the services provider, or any combination thereof. When the alert is generated, the alert displays an indicator on a display device in communication with the digital video recorder. In some implementations, where a calculation is performed based on a first criterion, the first criterion includes a change in the value of a financial asset.

In some implementations, there is a system for providing financial information from a financial services provider. The system includes a server adapted to associate a first customer information of a digital video recorder services provider and a second customer information of the financial services provider. The server is also adapted to provide the financial information from the financial services provider to a digital video recorder based on the first and second customer information.

In some implementations, the server is adapted to associate the first customer information and the second customer information by providing an identifier from the digital video recorder services provider to the financial services provider. The identifier is typically associated with a digital video recorder. In some implementations, the digital video recorder of the system is adapted to render the financial information. In some versions, the digital video recorder is further adapted to render the financial information including a visual component that describes the financial information in more detail. Additionally or alternatively, in some versions, the digital video recorder is further adapted to render the financial information including an audio component that describes the financial information in more detail. Also in some versions, the digital video recorder is further adapted to render the financial information including a textual component that describes the financial information in more detail. In some implementations of the system, the digital video recorder services provider provides digital content downloads to the digital video recorder and/or the financial services provider manages a financial asset.

In some implementations, there is a computer program product, tangibly embodied in an information carrier, for generating an alert signal. The computer program product includes instructions being operable to cause a data processing apparatus to receive a first information from a services provider and generate an alert signal based on the first information. The first information is typically associated with a customer and is unrelated to television programming. The alert signal is based on the first information and is generated on a digital video recorder associated with the customer.

Additionally, the method may include rendering the financial information via, e.g., a visual, audio, and/or textual component that describes the financial information in more detail. The digital video recorder services provider, in some implementations, provides digital content downloads to a digital video recorder. In some implementations, additionally or alternatively, the financial services provider manages a financial asset.

Several additional advantages are provided. Real-time alerts are generated and displayed to a DVR owner and/or user, financial information or tutorials are viewable by multiple people at once, and audio-visual and/or textual assisted reviews of financial statements are presented. Additionally, financial services-related content may be downloaded and reviewed by a DVR owner and/or user at his or her convenience.

Other aspects and advantages will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages will be more fully understood from the following description of various embodiments, when read together with the accompanying drawings, in which:

FIG. 1 depicts an architecture for an implementation of the invention;

FIG. 2 depicts an implementation employing the architecture of FIG. 1 in operation (represented as a timing diagram);

FIG. 3 depicts a process to generate an alert signal;

FIG. 4 depicts an implementation of an interface to create and/or modify where generated alerts are sent;

FIG. 5 depicts a watch list set up by the financial services customer; and

FIG. 6 depicts an implementation of an interactive statement.

### DETAILED DESCRIPTION

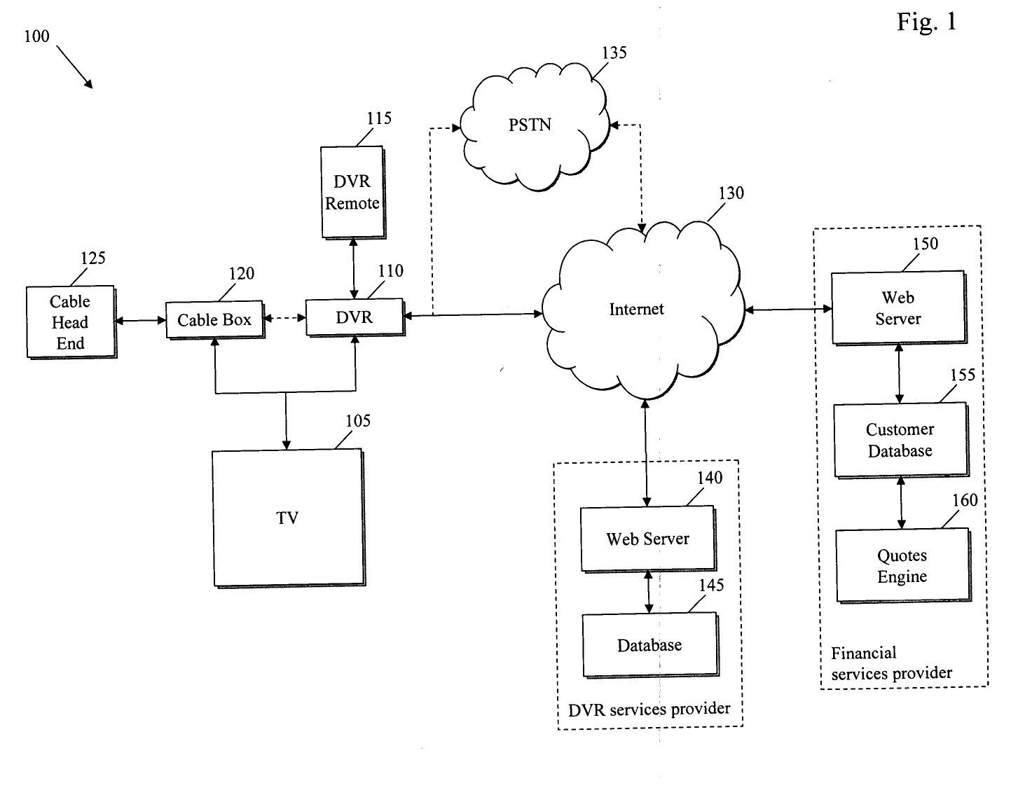

FIG. 1 depicts an architecture 100 for an implementation of the invention. The architecture 100 includes a TV 105, a DVR 110, and a DVR remote 115. The TV 105 serves as a display device for the DVR 110. The DVR 110 typically includes a hard drive, a computer processor, volatile and non-volatile memory, infrared, serial, Ethernet and/or wireless data connections, as well as video and audio inputs and outputs. The processor and memory in the DVR 110 are typically sufficient to enable the DVR 110 to encode and decode audio-visual content sent to the DVR 110, as well as encrypt and decrypt data communications and/or content sent and received by the DVR 110. The DVR remote 115 is in communication with the DVR 110, e.g., using infrared technology, and serves as an input device for the DVR 110. The DVR remote 115 typically has a full numeric keypad for input as well alpha-numeric interfaces with the DVR 110 via the display device, e.g., TV 105, to allow the user to enter a wide range of textual commands and/or inputs. Other input means, such as buttons on the DVR 110, or access to the DVR 110 through client application software executed on a computer in communication with the DVR 110, e.g., using a computer network in communication with the Ethernet or wireless connections of the DVR 110, may also be present. The architecture 100 also includes a cable box 120, which is in communication, e.g., over a coaxial cable connection, with a cable company head end 125. The cable box 120 decodes programming coming from the cable head end 125 and displays the programming on the TV 105. The cable company head end 125 provides programming to the cable box 120 such as channel content, e.g., a TV show, Video-On-Demand, and/or Pay-Per-View functionality. In some implementations, the DVR is implemented using a CableCARD™ or other Point-of-Deployment device. The CableCARD™ may be inserted into a set-top box to provide the set-top box with DVR and/or digital television tuning capabilities, or the CableCARD™ may be inserted directly into a display device 105, providing the display device 105 with digital television tuning and/or DVR functionality. In some implementations, the cable box 120 and DVR 110 are in communication (depicted as a dashed line) with each other, e.g., connected via a serial or IEEE 1394 (FireWire®) cable, or via infrared signals using an “IR Blaster” device.

The DVR 110 is also in communication (typically over the Internet 130 or a dial-up connection over a packet-switched telephone network (“PSTN” 135)) with a web server 140 owned and/or operated by the DVR services provider. The DVR services provider's web server 140 is a standard web server, but also provides TV show scheduling information to the DVR 110, as well as content downloads such as movie advertisements and special offers from the DVR services provider (e.g., deals on DVR hardware equipment or services). In some implementations, the DVR services provider's web server 140 also provides television advertisements, informational commercials (“infomercials”), and/or product placements in television shows, movies, and/or commercials. The DVR services provider's web server 140 is also in communication with a DVR services provider's database 145. The DVR services provider's database 145 is a standard database that also includes information about the owner of the DVR 110, the available TV show schedules per-region and time zone, as well as information associated with downloadable content. In some implementations, the DVR services provider's database also includes the name and/or names of the DVR owners and his or her family and/or household occupants (“owner and family”). Additionally, the DVR services provider's database may also include the owner and family's addresses (including zip code), one or more email addresses belonging to the owner and family, the owner and family's Internet Service Provider, if the DVR 110 is part of a local area network (LAN), and the owner and family's television viewing and/or DVR 110 recording history. In implementations where the DVR allows television shows to be rated, e.g., “thumbs up,” “thumbs down,” “I like this show” and/or “I do not like this show,” the DVR services provider's database may also include the DVR owner and family's television show ratings.

The DVR services provider's web server 140 is also in communication with a financial service provider's web server 150. The financial service provider's web server 150 is a standard web server, but also provides financial information associated with a financial services provider customer to the DVR services provider's web server 140. The financial services provider's web server 150 and the DVR services provider's web server 140 participate in a data negotiation transaction. In the transaction, the records of a customer of both the DVR services provider and the financial services provider are compared and associated with one another. For example, the DVR services provider's web server 140 provides the financial services provider's web server 150 with a customer identifier. The financial services provider's web server 150 then processes validation and security rules, and provides the DVR services provider's web server 140 with financial services provider information associated with that customer such as information about stocks that the customer owns or is keeping track of. In some implementations, the financial services providers web server 140 the DVR service provider's web server with the financial services provider's customer identifier. The financial service provider's web server 150 retrieves data associated with the customer from a financial services provider's customer database 155 that the financial services provider's web server 150 is in communication with. The financial services provider's customer database 155 is a standard database, but also includes data associated with the financial services provider's customers. The information may be assets owned by customers, gross and net worth, asset transaction history, and other financially-related information, balances, positions, charts, graphs, video, audio, or text relevant to the customer's assets. This information is provided to the financial services provider's web server 150 for publication to the DVR services provider's web server 140. The financial services provider's customer database 155 is also in communication with a financial services provider's quotes engine 160. The financial services provider's quotes engine 160 generates quotes on the value of particular assets at a particular time. For example, the financial services provider's quotes engine 160, provided with the current time of day, may return the current value of one share of Microsoft Corporation's stock, or where real-time data is not required, the value of one share of Microsoft Corporation's stock delayed by twenty minutes.

Additionally or alternatively, the financial services provider's quotes engine 160 provides quotes for purchasing financial assets such as annuities, certificates of deposit, bonds, or even for extending lines of credit such as mortgage quotes or credit card services.

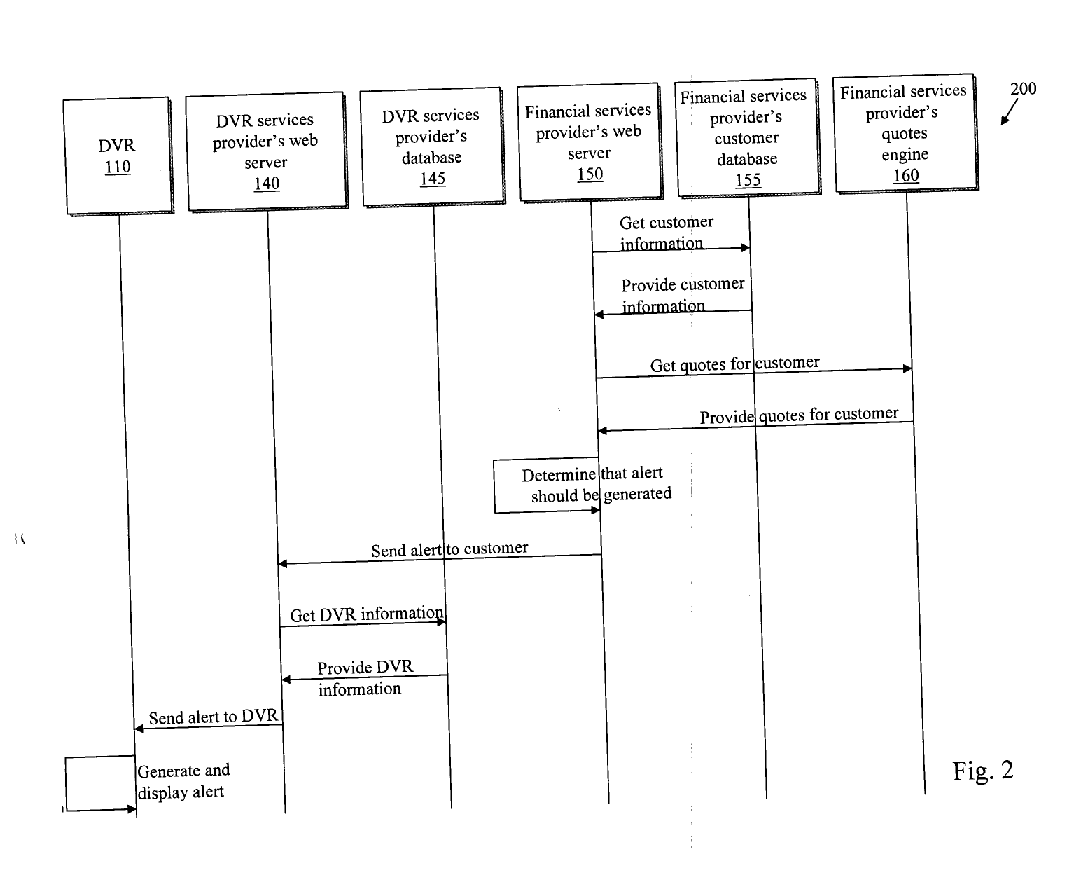

FIG. 2 depicts an implementation employing the architecture 100 of FIG. 1 in operation (represented as a timing diagram 200). The financial services provider's web server 150 requests the customer's financial services information from the financial services provider's customer database 155. The financial services provider's customer database 155 responds, providing the financial services provider's web server 155 with the customer's financial services information. The financial services provider's web server 155, based on the customer's financial services information, requests quotes from the financial services provider's quotes engine 160. The financial services provider's quotes engine 160 responds, providing quotes, such as the value of a particular stock, asset, or account value, to the financial services provider's web server 155. The financial services provider's web server 155 determines if an alert should be generated. If not, the process ends until the next time the financial services provider's web server 155 attempts to generate an alert signal. If the financial services provider's web server 155 determines that an alert should be generated, the alert signal is sent to the DVR services provider's web server 140 for display on the customer's DVR 110. The DVR services provider's web server 140 then requests information associated with the DVR 110 from the DVR services provider's database 145. The DVR services provider's database provides the information associated with the DVR 110 to the DVR services provider's web server 140, which in turn sends an alert signal to the customer's DVR 110. When an alert signal is received by the DVR 110, the DVR 110 generates an alert based on the received alert signal. The DVR then displays the alert on the TV 105 (not shown) by manipulating the output communication between the DVR 110 and the TV 105.

In some implementations, the information associated with a DVR 110 is a unique machine identifier, typically programmed into non-volatile memory inside the DVR 110, e.g., on a hard disk drive or ROM module. The DVR 110 is also typically associated with a subscriber identifier. The subscriber identifier is known to the DVR services provider and is used by the DVR services provider to track customer usage information, and to consolidate billing information where the customer owns multiple DVR 110 units. The subscriber identifier is associated with a customer identifier at the financial services provider such that the financial services provider is able to ascertain which subscriber to send personalized financial data to. An example of a customer identifier is a social security number, but may also be a unique identifier generated for the customer by the financial services provider. Additionally, in some implementations, the customer identifier of the financial services provider is associated with the subscriber identifier such that the DVR services provider may request financial services-oriented content from the financial services provider for a particular subscriber (or for a particular DVR 110 where a machine identifier is associated with a subscriber identifier). In some implementations, before the subscriber identifier of the DVR services provider and the customer identifier of the financial services provider are associated, the financial services provider associates a default profile with the subscriber identifier so that generalized financial services provider content may be sent to the subscriber's DVR 110. The default profile is used until the subscriber identifier and the customer identifier are associated, or for subscribers that are not customers of the financial services provider. For subscribers that are not customers of the financial services provider, the financial services provider may then generate alerts for the non-customer subscribers based on the default profile, which has alert criteria defined by the financial services provider. If a subscriber becomes a financial services provider customer, the subscriber identifier and the financial services customer identifier are then associated.

In some implementations, the information associated with the DVR 110 is provided to the financial services provider's web server 150 or financial services provider's customer database 155. In those implementations, the alert signal is sent from the financial services provider's web server 150 directly to the customer's DVR 110, bypassing the DVR services provider's web server 140 and the DVR services provider's database 145. In other implementations, the financial services provider's quotes engine 160 provides quotes to the financial services provider's web server 155 before the quotes are requested, e.g., at regular intervals or upon a change in asset value. The financial services provider's web server 155 then retrieves the customer information and skips the depicted step of retrieving quotes. The financial services provider's web server 155 determines if an alert should be generated and the process continues.

The architecture 100 is advantageous in that it allows the DVR services provider to present new and informative financially-oriented content to the customer, while not being burdened by managing the content since the content is produced and maintained by the financial services provider. Beneficially, the financial services provider obtains a user-friendly, familiar interface through which to provide financial information that promotes multi-user viewing. For example, users can watch the content on a TV 105 while sitting on the couch in their living room rather than huddled around a single, typically smaller, computer monitor.

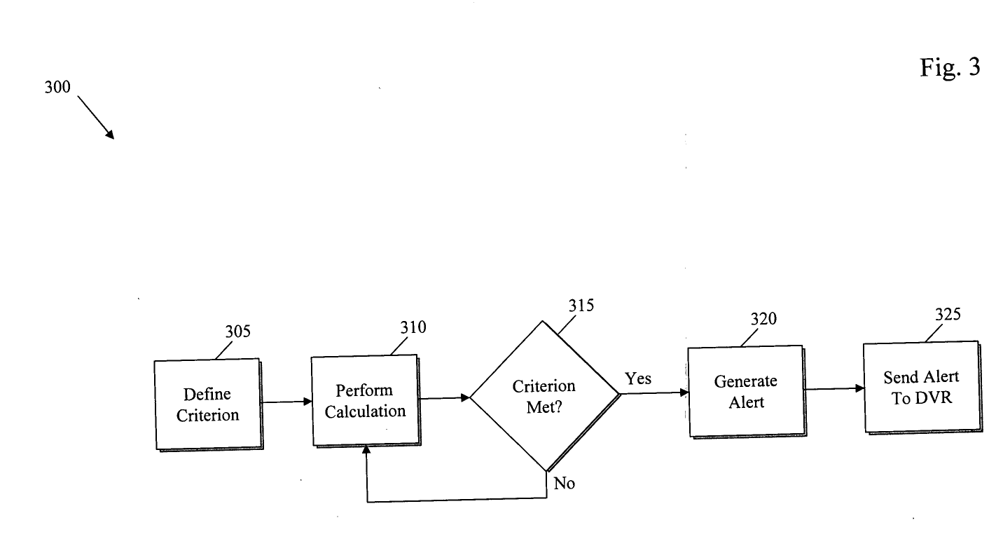

FIG. 3 depicts a process to generate an alert signal. The alert signal may appear as a new message in the DVR's (e.g., 110 depicted FIG. 1) menu interface, or the alert signal may pause the current content being displayed and present the alert to the viewer, giving the viewer the option to respond to the alert or to resume viewing the current content. Some exemplary alerts include a real-time change in the price of a stock owned by the customer, breaking news about a particular company, a group of companies, or a technology field, or general news that affects financial marketplaces. Alerts may also be information that the financial services provider or the DVR services provider wishes to make known to the customer. Alerts may also be investment information such as video programs about new financial service provider products, investment center location information such as maps, or directions from the customer's address. Additionally, in some implementations, content is downloaded and stored on the DVR's hard drive but is not available to be viewed (or even detected) until an alert is received or generated by the DVR, typically at a point in time after the content was downloaded, thereby “unlocking” the content in response to receiving the alert.

The process 300 defines (305) a criterion to test when determining that an alert is to be generated. In some implementations, the process 300 defines multiple criteria 305 to test. Implementations herein describing the use of a single criterion or multiple criteria are not limited to only the single criterion or the multiple criteria and the singular and plural forms are used interchangeably. Some exemplary criteria are if a financial asset has changed in value by a certain amount or if news has been released about a company whose stock the customer owns. Criteria associated with financial asset value may include determining if the value of the asset changing by a certain number of points (or a percentage) for one or more stocks of interest. In some implementations, the stocks are chosen by the customer, but the stocks may also be chosen by the financial services provider based on information the financial services provider has about the customer, e.g., other asset holdings, or investment strategy preferences such as capital preservation or aggressive capital growth, Other criteria may be if a certain date has occurred or if a certain asset is listed or de-listed, or an announcement of an initial public offering, a merger or acquisition, or a stock split. The criterion is stored either on the DVR, on the financial services provider's customer database, or on the DVR services database.

During the process 300, a calculation is performed (310) that tests the criteria. The calculation may be performed by the financial services provider, by the DVR services provider, or may be performed by the DVR itself. In some implementations the calculation is performed at the location the criteria is stored (e.g., if the criterion is stored on the DVR, the calculation is performed by the DVR). In other implementations, the criterion is stored on a different location and is accessed when performing the calculation. For example, the criterion may be stored on the financial services provider's customer database and the DVR may request criteria from the financial services provider's customer database (via the financial services provider's web server). The financial services provider's customer database, via the financial services provider's web server, responds, providing the criteria to the DVR. The DVR then performs (310) the calculation against the criteria.

During the process 300, the calculating device, e.g., the financial services provider's customer database or financial services provider's web server, or the DVR, also determines (315) if the criterion is met. If the criterion is not met, the calculating device performs (310) the calculation, optionally after a delay period (e.g., a minute, a day, a week, etc.). If the criterion is met, the calculating device generates (320) an alert. The calculating device, if not the DVR, sends (325) the alert to the DVR. If the DVR is the calculating device, then no signal needs to be sent since the alert is generated on the DVR.

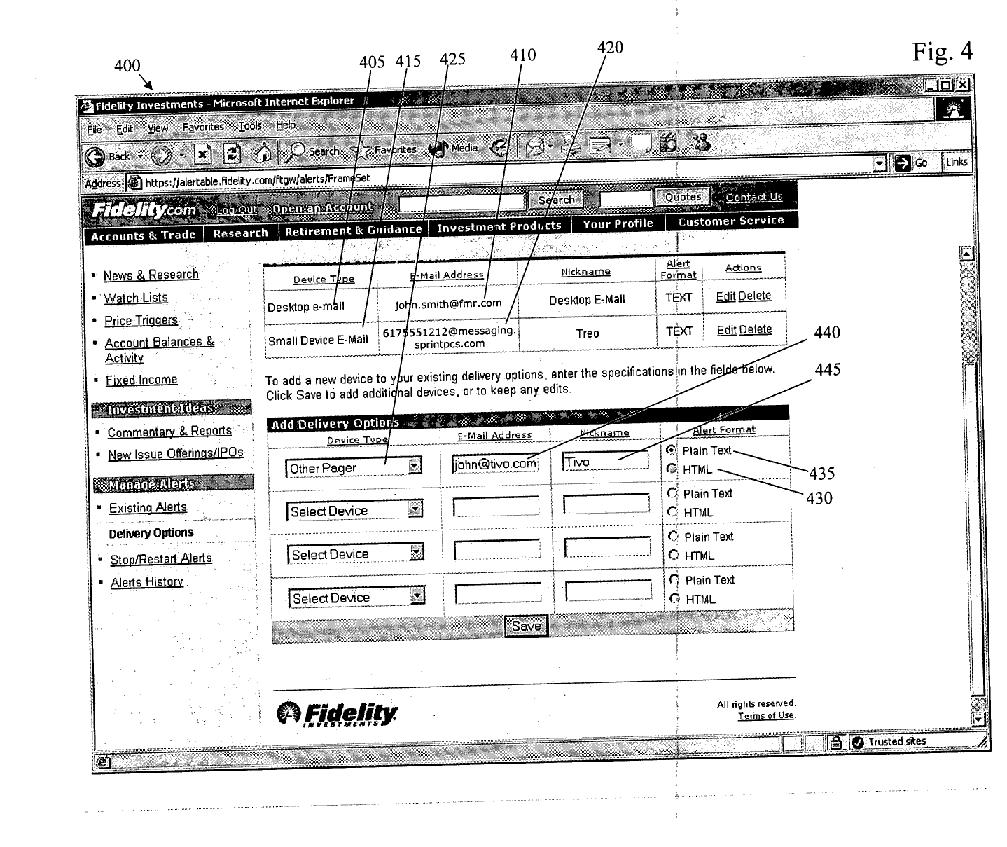

FIG. 4 depicts an implementation of an interface 400 to create and/or modify where generated alerts are sent. In some implementations, alerts may be sent to a desktop or laptop computer 405 via a standard email address 410, e.g., john smith@fmr.com. Additionally or alternatively, alerts may be sent to a mobile messaging device 415, e.g., a Personal Data Assistant (PDA) or a cellular phone, using, e.g., an email or a Short Message Service (SMS) message. In implementations where the alert is sent to a mobile messaging device, the mobile messaging device may be associated with a phone-number, an email address, and/or a combination of phone number and email address 420 (for example where the address is the user's phone number @ messaging.sprintpcs.com). When creating and/or modifying alerts, the user may specify a device type for the alert to be sent to (e.g., desktop 405, portable messaging device 415, or other pager 425). The user may also specify that alerts be sent using Hypertext Markup Language (HTML) 430 or sent using Plaintext 435. As an additional or alternative delivery method, alerts are also sent to a DVR 110. In the depicted implementation, the DVR 110 is identified by an email address 440 at the DVR service provider's domain, e.g., john@tivo.com. In some implementations, the identifier depicted as an email address 440 may instead be an identifier associated with the DVR 110. For example, a DVR 110 that uses the TiVo@-brand service (i.e., TiVo is the DVR services provider) is typically assigned a TiVo Service Number as an identifier, based on the hardware that comprises the DVR 110. The TiVo Service Number is typically a fifteen digit, alphanumeric identifier, e.g., 540-0001-7000-C8B7 assigned by TiVo and is associated with that specific DVR. Using the exemplary TiVo Service Number, some implementations of the interface 500 display, in area 440, “540-0001-7000-C8B7”. In some implementations, a DVR 110 is assigned an identifier by the DVR owner or user of the DVR 110, and then the identifier is associated with that particular DVR 110 by the DVR services provider. For example, financial services provider's customer may buy a TiVo@-brand DVR 110. During initial set up of the TiVog-brand DVR 110, the customer specifies a user-friendly name, e.g., “upstairs DVR” for the TiVo®-brand DVR 110 using the DVR remote 115. The customer then goes to the DVR services provider's website, e.g., Tivo.com, to enter personal information for billing purposes for the TiVo®-brand DVR 110 that he or she just initialized. While entering the personal information, the customer is prompted to input the TiVo Service Number for the TiVo®-brand DVR 110. The DVR service provider then receives the user-friendly name from the DVR 110 and the DVR service provider's web server 140 and/or database 145 associates the user-friendly name with the TiVo Service Number. This association is used to direct communications to and from the DVR 110 and the DVR services providers and to other content providers. For example, an alert can be sent to “upstairs TiVo”. The alert is generated and sent to the DVR service provider. The DVR services provider determines the TiVo Service Number associated with the user-friendly name (in some implementations by the DVR service provider's web server 140 and/or database 145). The DVR service provider's web server 140 then sends the alert to the “upstairs TiVo” DVR 110 via Ethernet, wireless, and/or phone line. In addition to specifying destinations 555, the user may also specify a nickname 445 for delivery methods so that the delivery method is easier for the user to remember.

Using the implementation depicted in FIG. 4, an exemplary alert is an email generated by the financial services provider's customer database 155, quotes engine 160, and web server 150 as described herein, and sent by the financial service provider's mail server (not shown) to the DVR service provider's mail server (not depicted). When the email is received by the DVR service provider's mail server, the DVR service provider's mail server communicates with the DVR service provider's web server 140 to inform the DVR service provider's web server 140 that an alert has arrived. The DVR service provider's mail server provides the DVR service provider's web server 140 with the alert message and the DVR service provider's web server 140 reformats the message for display on the owner's DVR 110 as an alert. The alert is sent to the DVR 110 and subsequently displayed on the display device 105 in communication with the DVR 110. In other implementations, the alert is created as a communication between financial service provider's web server 150 and the DVR service provider's web server 140 using a mutually-understood protocol over a network, wherein the destination of the alert, e.g., which DVR 110 the alert is sent to and subsequently displayed from, is created based on an identifier associated with the DVR 110.

In some implementations, the financial services provider delivers securities quotes or financial feeds to the DVR 110. The quotes may be real-time streaming, periodically downloaded, or delayed streaming, and are delivered over a high-speed internet connection or a dial-up connection. The feeds are, for example, a user-selected watch list of asset value quotes, a streaming feed of asset value as trades are made, or a list of quotes selected by the user and/or the financial services provider. Typically the quotes are a textual file, e.g., an extensible markup language (XML) file, that provides, but is not limited to, the symbol of a security or asset, the asking price per share, the selling price per share, and/or an indicator of when the prices were last determined. In some implementations, the quotes are sent as a binary file and/or stream. Once or as the quotes are received, the DVR 110 formats the quotes for display (e.g., determines quote font size, color, etc.) on a display device 105 in communication with the DVR 110 and displays the formatted quotes. The quotes may be displayed as streaming quotes overlaying a displayed program or the quotes may appear only when then device is tuned to a specific channel, during a previously recorded program, and/or during the display of downloaded content.

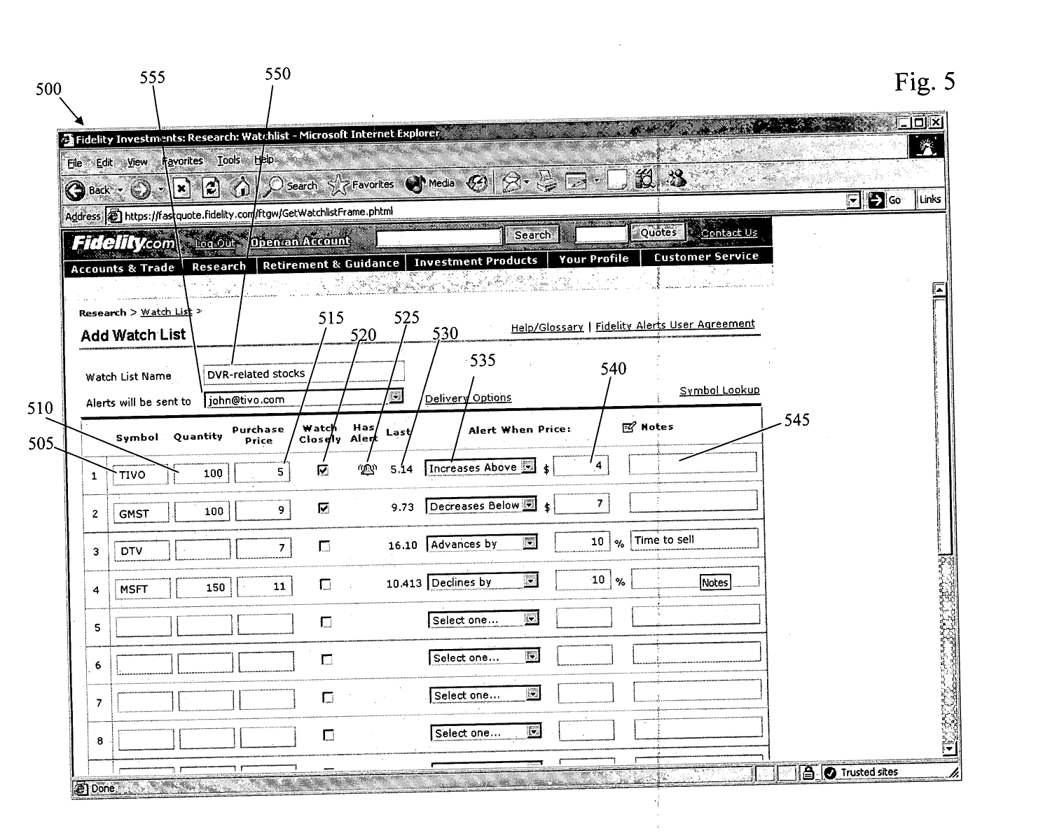

FIG. 5 depicts an interface 500 to a watch list set up by the financial services customer. The watch list is one or more assets that the financial services customer wishes to monitor. The interface 500 allows the customer to specify a particular stock or fund symbol 505 to monitor as part of a watch list. The watch list may be used in conjunction with the alert generation described herein, or may be used separately as a means of grouping assets that are interesting to the financial services customer. In addition to specifying an asset symbol 505, the interface 500 also allows the financial services customer to input a quantity 510 and a price 515 for an asset on the watch list. In some implementations the quantity and price reflect a number of assets owned by the financial services customer and the respective purchase prices thereof. In some implementations, however, the quantity and price reflect hypothetical amounts input by the financial services customer for research purposes or entertainment.

Another feature of the depicted implementation is the “watch closely” flag 520. If a particular asset is designated to be watched closely, the financial services provider provides more timely updates when comparing the asset to the alert criteria. For example, the financial services provider may normally provide updates for most symbols at twenty minute intervals, but update the value of assets marked “watch closely” every five minutes. A “has alert” icon 525 signifies that a particular asset has an alert assigned to the asset. As the price and/or value of the asset is updated, the “last” known value 530 is displayed in the watch list. In some implementations the interface 500 “reloads” the watch list at regular intervals to display an updated the last known value 530 for assets on the watch list. In implementations where the interface 500 is a web page, reloading may be accomplished by using an HTML “meta tag” that requests a new copy of the data that is displayed on the interface 500 from the financial service provider's web server 150. For example, an HTML meta tag that reloads (in HTML parlance, “refresh”) the interface 500 every five minutes would be, e.g., <meta http-equiv=“refresh” content=“300”>, where 300 represents the time between reload requests in seconds. HTML meta tags are typically described in the <HEAD> section of the HTML file that, when interpreted, is rendered as the interface 500.

In the depicted implementation, the interface 500 to the watch list provides dropdowns 535 to the customer that form the equality portion of a criterion, e.g., increases above, decreases below, advances by, declines by, etc. The equality portion 535 is combined with a value field 540 (when the changes to the interface 500 are saved to the financial service provider's web server 150) to form a criterion that, when evaluated to true, triggers the alert. The value field 540 may represent a dollar amount or a percentage. When combined, the equality, e.g., “decreases below”, and the value field, e.g., “7”, are used to determine if the alert should be generated. Using the example, if the GMST asset's value, currently 9, decreases below 7, the alert is generated.

Note fields 545 are also provided to the customer by the interface 500. In some implementations, note fields 545 are incorporated in alerts generated based on the watch list. The customer typically uses the notes fields 540 to send himself or herself useful reminders, e.g., time to sell, or to keep historical performance data in that is sent with the alerts, e.g., “bought at $5.00”. The interface 500 to the watch list also specifies a name 550, e.g., “DVR-related stocks” so that the customer may create multiple watch lists, the name further allowing the customer to identify what assets belong to a watch list, or to segregate watch lists by assets. The interface 500 to the watch list also specifies a destination 555, e.g., a DVR 110 or an email address associated with a DVR, for alerts that are generated. In implementations where a TiVo Service Number or a “user-friendly” identifier, e.g., “upstairs TiVo”, is associated with a particular DVR 110, the TiVo Service Number or the user-friendly identifier is the destination 555 of the alert.

In some implementations, the financial services provider delivers interactive statements, prospectuses, and/or sales material to the DVR via the architecture 100. The interactive statements (prospectuses, etc.) are visually, textually, and aurally (e.g., with sounds and speech) presented to a customer to “walk the customer through” a financial statement. Areas of the financial statement, such as asset allocation, balance, asset value, and others, may be selected or highlighted, and an audio-visual, and/or textual explanation of the area is presented to the viewer.

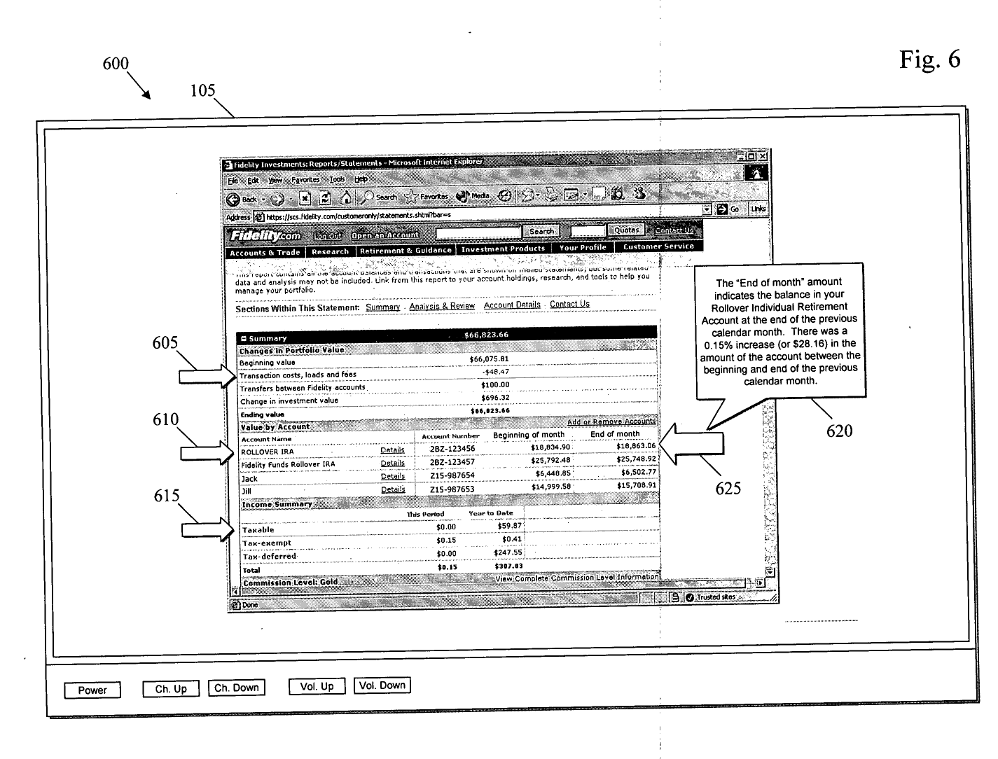

FIG. 6 depicts an implementation of an interactive statement 600. In the implementation depicted in FIG. 6, the statement 600 is presented on the DVR owner's television 105. The user interacts with the statement as described herein, e.g., using the DVR remote 115. The interactive statement 600 has areas that the user selects to gain more information. In the implementation depicted, the selectable areas are denoted by arrows, but changes in the font size or color, or graphics and icons, may be used as well. For the statement 600, the selectable areas include “Transaction costs, loads, and fees” 605, “Rollover IRA” 610, “Taxable” 615, and “End of month” 620. When selected (indicated by the large arrow 625), the “End of month” area 620 explains that the user's “End of month” amount indicates the balance in your Rollover Individual Retirement Account at the end of the previous calendar month. There was a 0.15% increase (or $28.16) in the amount of the account between the beginning and end of the previous calendar month.” When explaining a selected area, the implementation may convey the explanation using text, sounds and/or speech, and/or visuals. For example, using the “End of the month” selectable area 620, the implementation may display the text on the display device 105 in a manner similar to the depicted illustration, whereby the text appears next to, around, or super-imposed over, the selectable area 620, thus allowing the user to read the text until the user understands the text. The explanation may also be communicated to the user aurally, for example, by verbally speaking the words of the explanation to the user using text-to-speech synthesis, a pre-recorded audio track of an actor or actress reading the explanation, or a combination thereof. Additionally or alternatively, visuals may be displayed on the display device 105 that convey the explanation, such as displaying one or more pictures or presenting a movie or animation.

For example, in some implementations, a walkthrough of the equations used to generate a particular number or value are presented as a series of pictures showing balance and value. As the user indicates interactively that he or she understands this equation by, e.g., pressing a >> (fast forward) button on the DVR remote 115, the explanation continues and the next set of equations are explained. Beneficially, the user may also rewind the audio/visual explanations to review concepts that are not as well understood and listen/watch the audio/visual explanations again.

In the depicted implementation, if selected, the area describing transaction costs 605 explains that the costs associate with performing asset reallocations and/or stock sales totals $48.47. Optionally the explanatory material divides the transaction costs amount into the cost of each individual transaction. The Rollover IRA selectable area 610 describes the asset allocation and/or strategy of the investments that make up the customer's Individual Retirement Account. Optionally other accounts may be selected from the Account Summary section, e.g., Fidelity Funds Rollover IRA, Jack, and/or Jill. The taxable selection 615, when selected, explains what percentage of the financial services customer's income is taxable for the current quarter and/or year and why according to laws, rules, and regulations followed by the financial services provider. Optionally, the taxable selectable area 615 additionally explains what income is tax-deferred and what income is tax-exempt, and what the differences between the income categories of taxable, tax-exempt, and tax-deferred are.

Implementations combine advantageous aspects of the financial services and the DVR units and services to provide a beneficial viewing experience for the viewer.

The financial services-oriented content is presented using the DVR user interfaces, which are typically user-friendly and easily understood by users. The hard drive of the DVR unit stores financial services content which is not suitable for repeated or streaming downloads, such as asset trading and managing applications such as Active Trader Pro™ produced by Fidelity Investments®. Beneficially, financial services-oriented content is viewable by multiple viewers in a comfortable environment (e.g., the living room) that is suited for multi-user viewing.

In an implementation, the DVR services provider generates an alert that is delivered to a customer's DVR based on information the DVR services provider received from the financial services provider. In some implementations, however, the reverse is true; the financial services provider generates the alert based on information received from the DVR services provider. The information, irrespective of which party is generating the alert, is associated with the customer and/or the customer's financial assets. The information is typically financial information and may comprise a variety of data. The financial information may be a news story about a company that the customer has put in a “watch list” or a company whose stock the customer owns. The financial information may also be an increase or decrease of certain stock's price or percentage amount defined by the customer. Other examples of financial information that may be received by the DVR services provider is information about stocks selected by the customer to be monitored or put on a “watch list,” or the financial information may be a stream of financial data, a list of stock quotes selected by the services provider (e.g., stocks selected by either DVR services provider or the financial services provider), or any combination thereof.

In some implementations, to generate an alert signal, a calculation, typically based on information associated with a customer, is performed and the signal is generated by the DVR services provider when the calculation yields a result that meets a specified criterion. The criterion, in addition to the examples given above, may be if today is a specified day or is a predefined number of days before or after a particular date. The criterion may be a predetermined by the financial services provider, the DVR services provider, or by the user of the DVR.

The above-described techniques can be implemented in digital electronic circuitry, or in computer and/or DVR hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer and/or DVR are a processor for executing instructions and one or more memory devices for storing instructions and data. Generally, a computer and/or DVR also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer and/or DVR having a display device, e.g., a TV (standard definition and/or high definition), a CRT (cathode ray tube) or LCD (liquid crystal display) monitor, for displaying information to the user and remote control and/or a keyboard and/or a pointing device, e.g., a mouse or a trackball, by which the user can provide input to the computer ad/or DVR (e.g., interact with a user interface element). Other kinds of devices and/or software can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Interaction with the computer and/or DVR may take the form of data sent and/or received from application software on a second computer and/or DVR in communication with the first computer and/or DVR.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs executing on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A method for generating an alert signal comprising:
receiving a first information from a services provider, the first information associated with a customer and being unrelated to television programming; and
generating an alert signal based on the first information on a digital video recorder associated with the customer.

2. The method of claim 1 wherein the services provider is a digital video recorder services provider.

3. The method of claim 1 wherein the services provider is a financial services provider.

4. The method of claim 1 wherein the first information comprises financial information.

5. The method of claim 4 wherein the financial information comprises a news story about a company wherein the customer owns a share of stock of the company, a price for a stock owned by the customer, stocks selected to be monitored, a stream of financial data, a list of stock quotes selected by the services provider, or any combination thereof.

6. A method for generating an alert signal comprising:
performing a calculation based on a first information associated with a customer and being unrelated to television programming; and
generating an alert signal for use with a digital video recorder when the calculation meets a first criterion.

7. The method of claim 6 further comprising displaying an indicator on a display device in communication with the digital video recorder.

8. The method of claim 6 wherein the first criterion comprises a change in the value of a financial asset.

9. The method of claim 6 further comprising sending the alert signal from a services provider.

10. The method of claim 9 wherein the services provider is a digital video recorder services provider.

11. The method of claim 9 wherein the services provider is a financial services provider.

12. A system for providing financial information from a financial services provider comprising:
a server adapted to associate a first customer information associated with a digital video recorder services provider and a second customer information associated with the financial services provider; and
to provide the financial information from the financial services provider to a digital video recorder based on the first and second customer information.

13. The system of claim 12 wherein the server is adapted to associate the first customer information and the second customer information by providing an identifier from the digital video recorder services provider to the financial services provider.

14. The system of claim 13 wherein the identifier is associated with a digital video recorder.

15. The system of claim 12 further comprising the digital video recorder adapted to render the financial information.

16. The system of claim 15 wherein the digital video recorder is further adapted to render the financial information including a visual component that describes the financial information in more detail.

17. The system of claim 15 wherein the digital video recorder is further adapted to render the financial information including an audio component that describes the financial information in more detail.

18. The system of claim 15 wherein the digital video recorder is further adapted to render the financial information including a textual component that describes the financial information in more detail.

19. The system of claim 12 wherein the digital video recorder services provider provides digital content downloads to the digital video recorder.

20. The system of claim 12 wherein the financial services provider manages a financial asset.

21. A computer program product, tangibly embodied in an information carrier, for generating an alert signal, the computer program product including instructions being operable to cause a data processing apparatus to:
receive a first information from a services provider, the first information associated with a customer and being unrelated to television programming; and
generate an alert signal based on the first information on a digital video recorder associated with the customer.
